(19) United States
(12) Patent Application Publication
(10) Pub. No.: US 2026/0208597 A1
(43) Pub. Date: Jul. 23, 2026

(54) ELECTRONICS FOR ONBOARD SOLAR POWER

(71) Applicant: GM GLOBAL TECHNOLOGY OPERATIONS LLC, DETROIT, MI (US)

(72) Inventors: Ian J. Sutherland, Grosse Pointe, MI (US); Shyh-yeu Jao, Bloomfield Hills, MI (US); Mohamed Ahmed Kamel Ahmed, Birmingham, MI (US); Jennifer Bauman, Cambridge, ON (CA); Zahra Sadegh, Hamilton, ON (CA)

(21) Appl. No.: 19/033,898

(22) Filed: Jan. 22, 2025

(51) Int. Cl. B60L 8/00; H02J 3/38; H02J 7/35

(52) U.S. Cl. CPC B60L 8/003; H02J 3/381; H02J 7/35; B60L 2210/14; H02J 2101/25; H02J 2105/37; H02J 2207/20

(57) ABSTRACT

A system includes a charging module connected to a battery system of a vehicle, the charging module including a direct current (DC)-DC converter, a solar power system including a conversion device electrically connected to a solar panel array disposed on the vehicle, the conversion device having a direct electrical connection to an internal component of the charging module, and a controller configured to control operation of the conversion device and the charging module to transfer power from the solar panel array to the battery system, or to transfer power from the solar panel array to an external electrical system.

### INTRODUCTION

The subject disclosure relates to vehicle electrical systems, and more particularly to vehicle systems that include batteries and solar power systems.

Vehicles, including gasoline and diesel power vehicles, as well as electric and hybrid electric vehicles, feature battery storage for purposes such as powering electric motors, electronics and other vehicle subsystems. Battery assemblies may be charged using dedicated charging stations and other power sources such as residences and buildings connected to a power grid. Solar energy can be employed to charge the batteries, for example, by installing solar panels on exterior vehicle components.

### SUMMARY

In one exemplary embodiment, a system includes a charging module connected to a battery system of a vehicle, the charging module including a direct current (DC)-DC converter, a solar power system including a conversion device electrically connected to a solar panel array disposed on the vehicle, the conversion device having a direct electrical connection to an internal component of the charging module, and a controller configured to control operation of the conversion device and the charging module to transfer power from the solar panel array to the battery system, or to transfer power from the solar panel array to an external electrical system.

In addition to one or more of the features described herein, the internal component is a DC link, and the direct electrical connection is a direct DC connection to the DC link.

In addition to one or more of the features described herein, the charging module includes a rectifier connected to the DC-DC converter by the DC link, and the conversion device is directly connected to a midpoint of the DC link.

In addition to one or more of the features described herein, the direct electrical connection is between the conversion device and the DC-DC converter.

In addition to one or more of the features described herein, the conversion device is an isolated DC-DC converter.

In addition to one or more of the features described herein, the power from the solar panel array is transmitted from the conversion device solely to the charging module.

In addition to one or more of the features described herein, the solar power system includes a plurality of solar panels, the conversion device is an isolated DC-DC converter, and the plurality of solar panels are connected in parallel to the isolated DC-DC converter.

In addition to one or more of the features described herein, the solar power system includes a plurality of solar panel arrays, and the conversion device includes a respective isolated DC-DC converter connected to each solar panel array.

In addition to one or more of the features described herein, the conversion device is an isolated DC-DC converter, and the solar power system includes a plurality of solar panel arrays, each solar panel array connected to the isolated DC-DC converter via a respective maximum power point tracking (MPPT) converter.

In another exemplary embodiment, a method of transferring electrical power includes receiving low voltage electrical power from a solar panel array disposed on a vehicle at a conversion device, the conversion device electrically connected to the solar panel array, the conversion device having a direct electrical connection to an internal component of a charging module, the charging module connected to a battery system of the vehicle. The method also includes stepping up the low voltage electrical power to generate stepped up electrical power and transmitting the stepped up electrical power to the internal component, and transmitting the stepped up electrical power to at least one of the battery system and an external system.

In addition to one or more of the features described herein, the charging module includes a direct current (DC)-DC converter, the direct electrical connection is to the DC-DC converter or to a DC link within the charging module, and transmitting the stepped up electrical power includes providing the stepped up electrical power via the direct electrical connection and converting the stepped up electrical power to high voltage electrical power and charging the battery system.

In addition to one or more of the features described herein, the charging module includes a rectifier connected to the DC link and a charge port, and transmitting the stepped up electrical power includes converting the stepped up electrical power to AC power.

In addition to one or more of the features described herein, the stepped up electrical power from the solar panel array is transmitted from the conversion device solely to the charging module.

In addition to one or more of the features described herein, the solar power array includes a plurality of solar panel arrays, the conversion device is an isolated DC-DC converter, and the plurality of solar panel arrays are connected in parallel to the isolated DC-DC converter.

In addition to one or more of the features described herein, the solar power array includes a plurality of solar panel arrays, and the conversion device includes a respective isolated DC-DC converter connected to each solar panel array.

In addition to one or more of the features described herein, the conversion device is an isolated DC-DC converter, and the solar power array includes a plurality of solar panel arrays, each solar panel array connected to the isolated DC-DC converter via a respective maximum power point tracking (MPPT) converter.

In yet another exemplary embodiment, a vehicle system includes a solar panel array disposed on a vehicle, a battery system, a charging module connected to the battery system, the charging module including a direct current (DC)-DC converter, and a solar power system including a conversion device electrically connected to the solar panel array, the conversion device having a direct electrical connection to an internal component of the charging module. The vehicle system also includes a controller configured to control operation of the conversion device and the charging module to transfer power from the solar panel array to the battery system, or to transfer power from the solar panel array to an external electrical system.

In addition to one or more of the features described herein, the charging module includes a rectifier connected to the DC-DC converter by the DC link, and the conversion device is directly connected to a midpoint of the DC link.

In addition to one or more of the features described herein, the internal component is a DC link, and the direct electrical connection is a direct DC connection to the DC link.

In addition to one or more of the features described herein, the direct electrical connection is between the conversion device and the DC-DC converter.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including a battery assembly and a solar energy charging system, in accordance with an exemplary embodiment;

FIG. 2 is a perspective view of the motor vehicle of FIG. 1, including an array of solar panels, in accordance with an exemplary embodiment;

FIG. 3 is a schematic diagram of an electrical system of a vehicle, including a solar power conversion device and a charging module, in accordance with an exemplary embodiment;

FIG. 4 is a schematic diagram of an electrical system of a vehicle, including a solar power conversion device and a charging module, in accordance with an exemplary embodiment;

FIG. 5 is a schematic diagram of an electrical system of a vehicle, including a solar power conversion device and a charging module, in accordance with an exemplary embodiment;

FIG. 6 is a schematic diagram of an electrical system of a vehicle, including a solar power conversion device and a charging module, in accordance with an exemplary embodiment;

FIG. 7 is a schematic diagram of an electrical system of a vehicle, including a solar power conversion device and a charging module, in accordance with an exemplary embodiment;

FIG. 8 depicts an electrical system, as well as control functions and power flow, in accordance with an exemplary embodiment;

FIG. 9 depicts a control system incorporated in a vehicle controller, in accordance with an exemplary embodiment;

FIG. 10 depicts a distributed control system, in accordance with an exemplary embodiment; and

FIG. 11 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods, devices and systems are provided for managing transmission and storage of solar energy from a vehicle solar power system. An embodiment of a system includes a charging module connected to a battery system (e.g., high voltage (HV) battery pack). The charging module includes a direct current (DC)-DC converter and a rectifier, which are connected within the charging module by an internal DC link.

An embodiment of a solar power system includes a conversion device, such as a DC-DC converter configured to step up or boost voltage from solar power generated by onboard solar panel arrays. The conversion device has a direct electrical (DC or alternating current (AC)) connection to an internal component of the charging module (e.g., the DC link or the DC-DC converter within the charging module). A controller controls operation of the conversion device and the charging module to transfer power from the solar panel array to the battery system, and/or to transfer power from the solar panel array to an external electrical system, such as an AC power grid. As described herein, an “internal component” is a component of a charging module, which may be disposed within a housing of the charging module or otherwise form part of the charging module.

Embodiments described herein present numerous advantages and technical effects. Embodiments provide for improvements, for example, by bridging potentially large differences in voltage between energy from the solar panel arrays and voltages associated with vehicle batteries and AC power grids. In addition, embodiments provide this improved functionality using minimal additional components (e.g., only a single DC-DC converter), as compared to conventional control systems where power from solar panel arrays is handled through multiple different paths (e.g., distinct paths to a vehicle bus, high voltage battery, and low voltage battery).

Furthermore, by using an existing link or other component of a charging module, embodiments provide for a simpler system that has fewer components and less complexity than conventional systems. In addition, boost transformers in solar DC-DC converter(s) can be reduced in size as compared to non-integrated modules (e.g., have lower turns ratio). For example, embodiments allow for stepping up solar power voltage to an intermediate voltage (e.g., the voltage of a DC link within the charging module) prior to providing the solar power to the charging module. As such, a solar DC-DC converter need only step up voltage from the solar voltage to the intermediate DC link voltage (as opposed to stepping up from the initial solar power voltage all the way to the battery system voltage), which allows for a lower turns ratio. Other advantages include simplification of control architecture by re-using existing controllers, and provision of a shorter path to grid or offboard storage in cases where solar energy discharges to external loads.

The embodiments are not limited to use with any specific vehicle or device or system that utilizes battery assemblies, and may be applicable to various contexts. For example, embodiments may be used with automobiles, trucks, aircraft, construction equipment, farm equipment, automated factory equipment and/or any other device or system that may use solar power and battery storage.

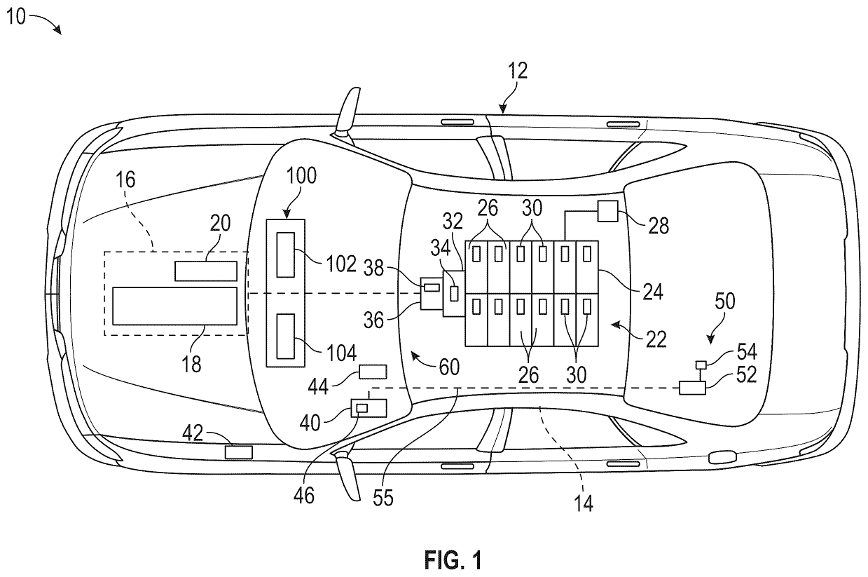

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, a fuel injection subsystem, an exhaust subsystem and others.

The vehicle 10 may be a combustion engine vehicle, an electrically powered vehicle (EV) or a hybrid electric vehicle (HEV). In an example, the vehicle 10 is a hybrid vehicle that includes a combustion engine 18 and an electric motor 20.

The vehicle 10 includes a battery system 22, which may be electrically connected to the motor 20 and/or other components, such as vehicle electronics. In an embodiment, the battery system 22 is configured as a rechargeable energy storage system (RESS). In an embodiment, the battery system 22 includes a battery assembly such as a high voltage (HV) battery pack 24 (e.g., 400 V or 800 V) having a plurality of battery modules 26. Each of the battery modules 26 includes a number of individual cells (not shown). The battery system 22 may also include a battery controller 28 configured to receive measurements from sensors 30 and/or control charging and discharging. Each sensor 30 may be an assembly or system having one or more sensors for measuring various battery and environmental parameters, such as temperature, current and voltages.

The battery system 22 includes various conversion devices for controlling the supply of power from the battery pack 24 to the motor 20 and/or electronic components. The conversion devices may include a DC-DC converter module 32 including a DC-DC converter 34. The conversion devices also include an inverter module 36 that includes an inverter 38. The inverter 38 receives DC power from the DC-DC converter 34 and converts DC power to AC power that is supplied to the electric motor 20.

The vehicle 10 also includes a charging system, which can be used to charge the battery system 22 and/or to supply power from the battery system 22 to charge another energy storage system (e.g., vehicle-to-vehicle (V2V) and/or vehicle-to-everything (V2X) charging). The vehicle charging system includes a charging control device 40, such as an onboard charging module (OBCM) 40 connected to a charge port 42. The OBCM 40 may include a control device such as an OBCM controller 46.

The vehicle 10 also includes a solar power system 50 configured for generating solar energy via one or more solar panels (not shown), also referred to as photovoltaic (PV) panels. The solar energy system 50 includes a conversion device 52 (solar conversion device) for stepping up or stepping down voltage of the electrical output of the PV panels. Voltage control is used, for example, to step up voltage for charging the HV battery pack 24 or providing power to an external grid or storage device. Control of the conversion device 52 may be realized via a solar power system controller 54.

The conversion device 52, in an embodiment, has a direct electrical connection to the OBCM 40. This connection is represented as conductor 55, which provides a direct path to the OBCM 40. The conductor 55 may be connected to an existing DC link in the OBCM 40, or provide a direct electrical connection to another internal component of the OBCM 40, as discussed further herein.

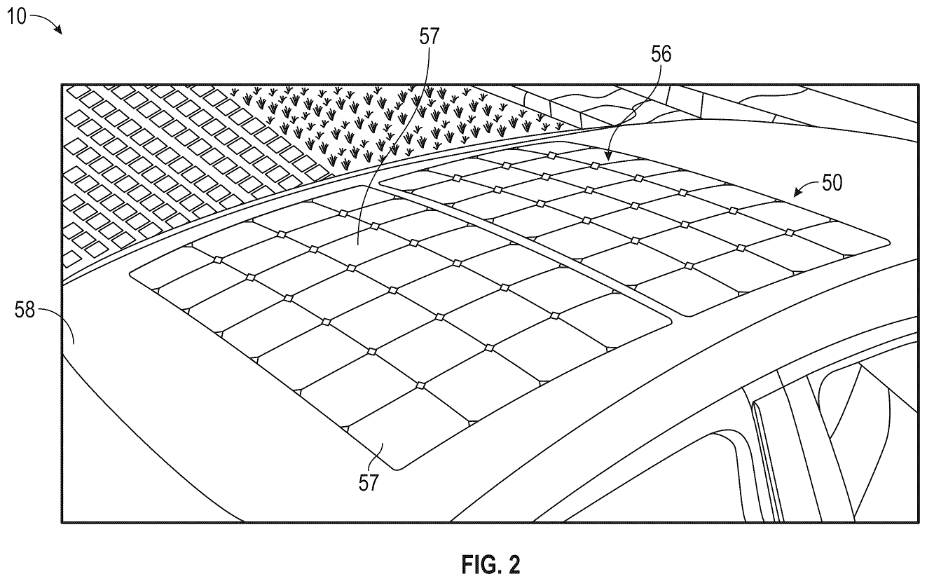

FIG. 2 depicts an example of a solar panel array 56 that includes a set of PV cells 57 disposed on a roof section 58 of the vehicle 10. The solar panel array 56 is electrically connected to the conversion device 52 (FIG. 1). One or more solar panel arrays 56, each of which includes any desired number and arrangement of solar panels and cells, may be mounted at various locations. Examples of such locations include the vehicle's hood and rear section.

Referring again to FIG. 1, the vehicle 10 includes at least one processor or processing device for controlling aspects of solar energy charging and transmission, referred to as a processor 44. The processor 44 may be a separate device as shown, or a controller that is part of an existing vehicle component or system. For example, the processor 44 may be a vehicle controller, the OBCM controller 46, the battery controller 28 or combination of multiple controllers. It is noted that embodiments are not limited to any specific controller or processing device, and may encompass multiple processors or control devices.

The vehicle 10 also includes a computer system 100 that includes one or more processing devices 102 and a user interface 104. The computer system 100 may communicate with a controller or vehicle system, for example, to provide commands thereto in response to a user input. The various processing devices, modules and units may communicate with one another via a communication device or system, such as a controller area network (CAN) or transmission control protocol (TCP) bus.

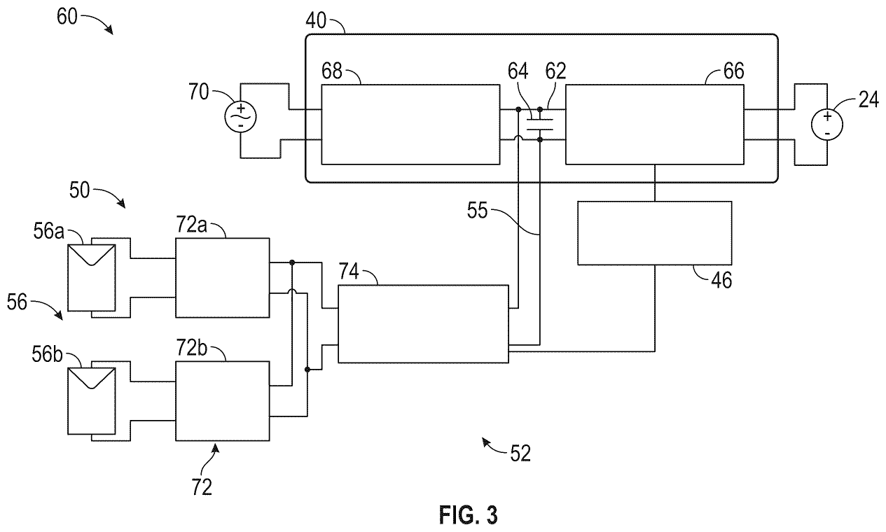

FIGS. 3-7 depict embodiments of an electrical system 60 of a vehicle, such as the vehicle 10. In these embodiments, the OBCM 40 houses internal components that include an isolated DC-DC converter 66, an internal DC link 62 and a capacitor 64. The isolated DC-DC converter 66 is configured to step up voltage of power used to charge the battery pack 24, and may also be configured to step down voltage when discharging.

The internal components also include, for example, a rectifier 68 configured to convert AC power from a power grid 70 (e.g., residential electrical system, municipal power grid, AC charging station, etc.) to DC power for charging the battery pack 24. The rectifier 68 also converts DC power to AC power when providing power to the power grid 70. It is noted that the rectifier 68 and/or the isolated DC-DC converter may be unidirectional or bi-directional.

Referring to FIG. 3, in an embodiment, the solar power conversion device 52 includes multiple components. More specifically, the conversion device 52 includes a maximum power point tracking (MPPT) converter 72 (denoted as MPPT converters 72a and 72b) connected to each solar panel array 56 on the vehicle 10. For example, the vehicle 10 includes two solar panel arrays 56a and 56b (e.g., a roof array and a rear array). The solar panel array 56a is connected to a respective MPPT converter 72a, and the solar panel array 56b is connected to a respective MPPT converter 72b.

The conversion device 52 further includes an isolated DC-DC converter 74. The isolated DC-DC converter 74 receives power from each MPPT converter, and also has a direct electrical connection to the OBCM 40 (conductor 55). In this embodiment, the direct connection is to the DC link 62 (e.g., the conductor 55 is connected to a midpoint of the DC link 62). In this way, power from the solar power system 50 flows directly and solely to the OBCM 40.

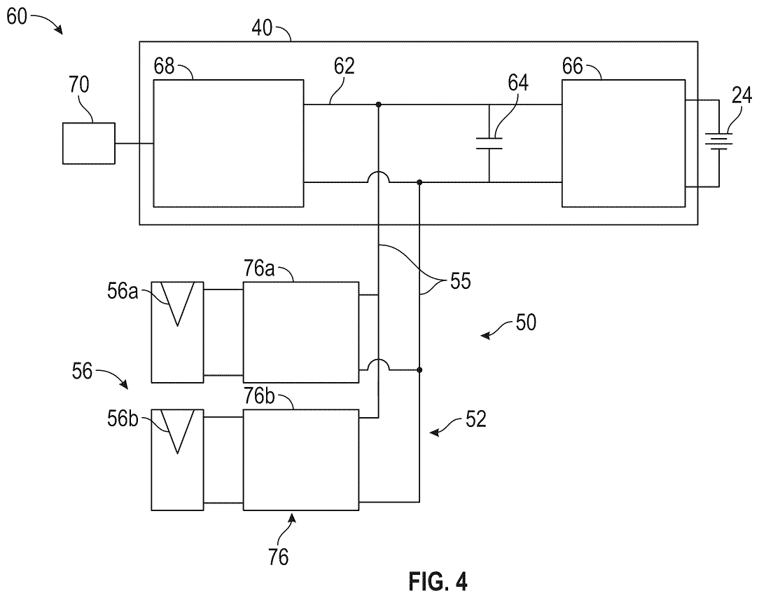

FIG. 4 depicts an embodiment of the electrical system 60, in which the conversion device 52 includes a single isolated DC-DC converter 76 between each solar panel array 56 and the OBCM 40. For example, each solar panel array 56a and 56b is connected to a respective DC-DC converter 76a and 76b, each of which has MPPT capability to optimize voltage conversion. The DC-DC converters 76a and 76b are each directly connected to the OBCM 40 at the DC link 62.

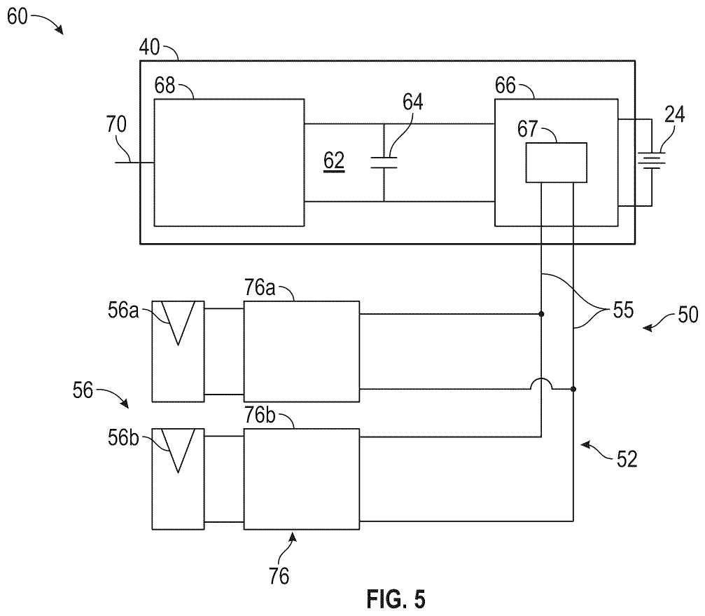

The direct electrical connection may be to any suitable component of the OBCM 40. FIG. 5 shows an embodiment of the electrical system 60 in which the direct connection is to the isolated DC-DC converter 66. The conductor 55 is connected to the DC-DC converter 66 in any suitable manner, such as via a multi-port transformer 67 in the DC-DC converter 66.

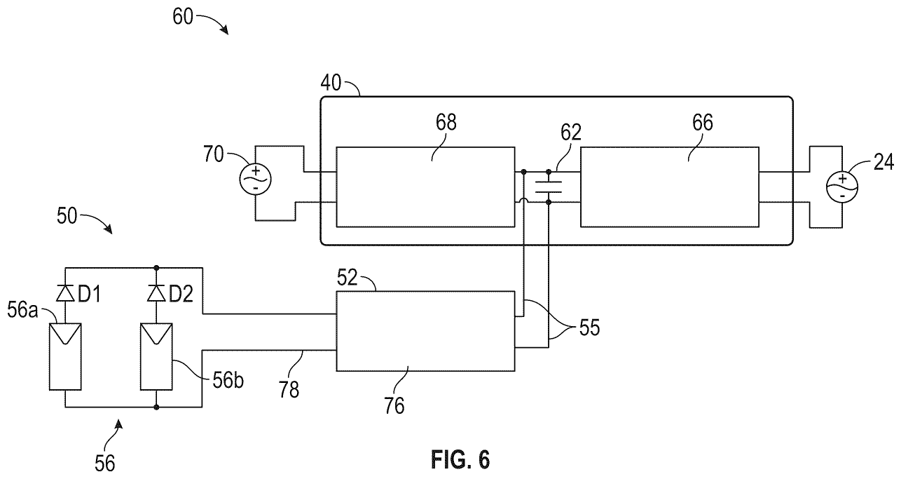

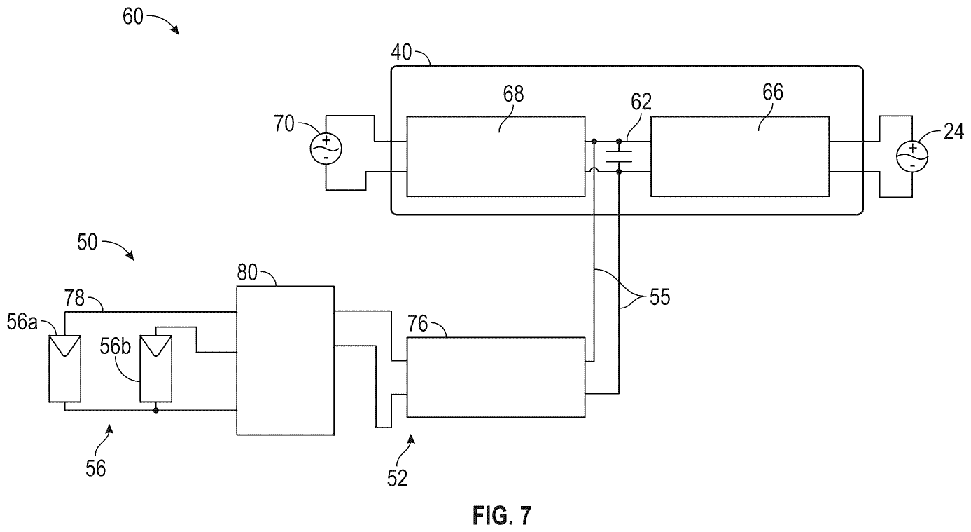

FIGS. 6 and 7 show additional embodiments of the electrical system 60. In these embodiments, the direct electrical connection is shown as being to the DC link 62. However, these embodiments are not so limited, as the direct electrical connection may be to any suitable internal component of the OBCM 40, such as the isolated DC-DC converter 66.

FIG. 6 depicts an embodiment of the electrical system 60, in which the conversion device 52 includes a single converter between a plurality of solar panel arrays and the OBCM 40. The solar panel arrays 56a and 56b are connected in parallel to a bus 78 and to respective diodes D1 and D2. The bus 78 is connected to a single isolated DC-DC converter 76. This embodiment is useful, for example, if the solar panel arrays are all of the same type.

FIG. 7 depicts another embodiment of the electrical system 60. In this embodiment, the conversion device 52 includes a multi-port MPPT converter 80 connected to a plurality of solar panel arrays 56a and 56b. The multi-port converter 80 outputs to the isolated DC-DC converter 76.

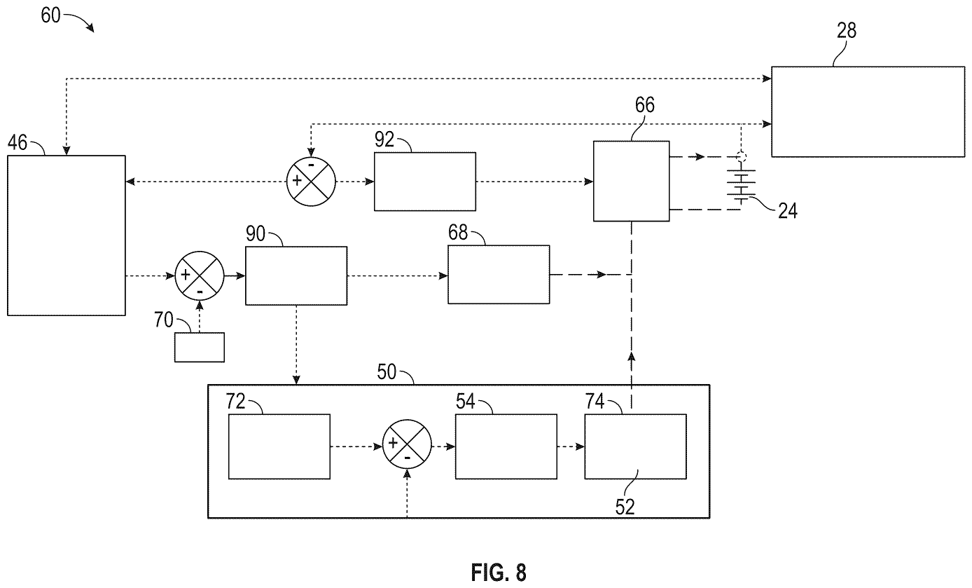

FIG. 8 schematically depicts an example of the electrical system 60, and illustrates aspects of a method of power transfer. The method generally includes supplying power from a solar panel array or arrays to charge a battery system, and/or supplying power from an external grid to charge the battery system. The method may include charging the battery system using solar power or grid power, or concurrently charging the battery system using both grid and solar power.

The method begins by sending a charging request from the battery controller 28 to the OBCM controller 46. The charging request may include a target state of charge. The OBCM controller 46 outputs a target or reference value, such as a reference current i_{ref}, a reference voltage v_{ref} and/or a reference power p_{ref}.

Power from the power grid 70 (current i_{grid}) is routed to the rectifier 68. A controller 90 controls the rectifier 68 and may also communicate with the solar power system controller 54 to coordinate power output with the solar power system 50.

As power flows from the solar panel array(s) and/or the grid 70 to the battery pack 24, a DC-DC converter controller 92 controls the DC-DC converter 66 to step up voltage to the battery pack 24 voltage (e.g., 400, 800 V). For example, power is boosted via the isolated DC/DC converter 66 within the OBCM 40 to charge the HV Battery, either continuously or in pulses (burst mode) depending on power level.

In an embodiment, the solar conversion device 52 steps up voltage to an intermediate voltage and sends the stepped up power as current iₛₒₗₐᵣ to the isolated DC-DC converter 66. If grid power is being used to charge, the rectifier 68 outputs a current i_{rectifier}, which may be processed to have the same voltage as the conversion device 52 output.

The DC-DC converter 66 then steps up the voltage to a target voltage for the battery pack 24. For example, the solar arrays output a low voltage current (e.g., 24-48 Volts (V)), which is stepped up to an intermediate voltage (e.g., 100-200 V), and then stepped up again by the DC-DC converter 66 to a target voltage (e.g., 900 V). In an embodiment, the intermediate voltage corresponds to the voltage at the DC link 62 (FIGS. 3-7).

The method may also include exporting power from the battery pack 24 and/or the solar power system 50 to supply power to the grid 70 (or other external device or system). Power from the battery pack 24 is supplied to the DC-DC converter 66, which steps down voltage to the grid voltage. Solar power is stepped up to the grid voltage by the conversion device 52 and routed to the rectifier 68. The rectifier 68 converts received power to AC and then outputs AC power to the grid 70. In power export mode (vehicle-to-grid or V2G), the OBCM 40 may reduce HV battery power flow to prioritize export of solar power over export of battery power.

A control device or system used to control charging and discharging processes may take any suitable form and have any number of processors. For example, the control system may be the processor 44 (FIG. 1), the OBCM controller 46 or a combination thereof.

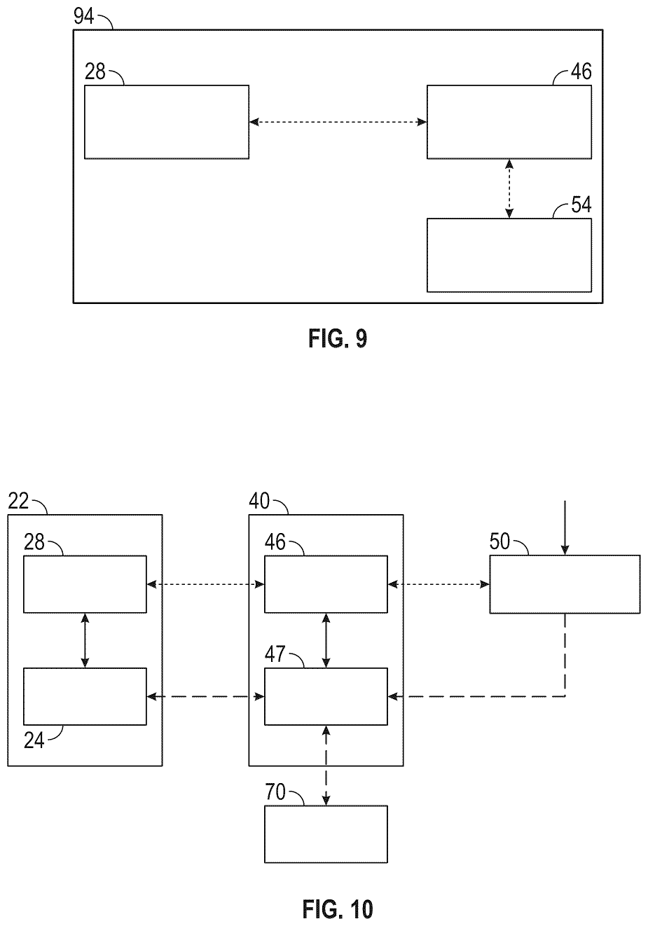

FIGS. 9 and 10 depict embodiments of the control system. In the embodiment of FIG. 9, the control system includes controllers incorporated into a vehicle controller 94. Specifically, the battery controller 28, the OBCM controller 46 and the solar power system controller 54 are all incorporated into the vehicle controller 94. The controllers may be incorporated into a single module making up the vehicle controller 94.

In the embodiment of FIG. 10, the control system is distributed, such that each controller is separately incorporated into a respective component. Specifically, the battery controller 28 is part of the battery system 22, the OBCM controller 46 is part of the OBCM 40, and the solar power system 50 has its own dedicated controller. These controllers work in cooperation to perform the methods described herein.

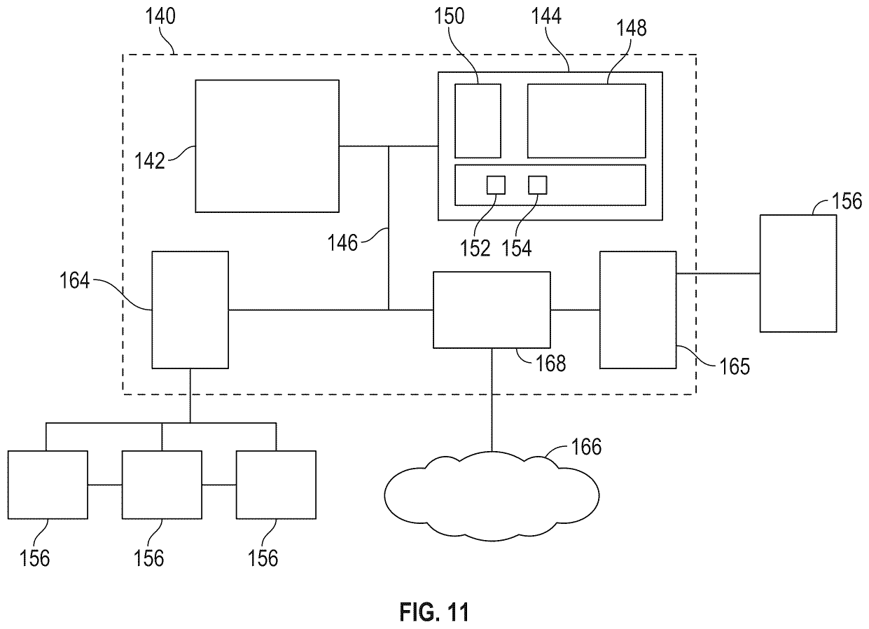

FIG. 11 illustrates aspects of an embodiment of a computer system 140 that can perform various aspects of embodiments described herein. The computer system 140 includes at least one processing device 142, which generally includes one or more processors for performing aspects of power flow management methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module 152 may be included for performing functions related to monitoring system components, and a module 154 may be included to perform functions related to controlling charging operations as discussed herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 140. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system comprising:
a charging module connected to a battery system of a vehicle, the charging module including a direct current (DC)-DC converter;
a solar power system including a conversion device electrically connected to a solar panel array disposed on the vehicle, the conversion device having a direct electrical connection to an internal component of the charging module; and
a controller configured to control operation of the conversion device and the charging module to transfer power from the solar panel array to the battery system, or to transfer power from the solar panel array to an external electrical system.

2. The system of claim 1, wherein the internal component is a DC link, and the direct electrical connection is a direct DC connection to the DC link.

3. The system of claim 2, wherein the charging module includes a rectifier connected to the DC-DC converter by the DC link, and the conversion device is directly connected to a midpoint of the DC link.

4. The system of claim 1, wherein the direct electrical connection is between the conversion device and the DC-DC converter.

5. The system of claim 1, wherein the conversion device is an isolated DC-DC converter.

6. The system of claim 1, wherein the power from the solar panel array is transmitted from the conversion device solely to the charging module.

7. The system of claim 1, wherein the solar power system includes a plurality of solar panels, the conversion device is an isolated DC-DC converter, and the plurality of solar panels are connected in parallel to the isolated DC-DC converter.

8. The system of claim 1, wherein the solar power system includes a plurality of solar panel arrays, and the conversion device includes a respective isolated DC-DC converter connected to each solar panel array.

9. The system of claim 1, wherein the conversion device is an isolated DC-DC converter, and the solar power system includes a plurality of solar panel arrays, each solar panel array connected to the isolated DC-DC converter via a respective maximum power point tracking (MPPT) converter.

10. A method of transferring electrical power, comprising:
receiving low voltage electrical power from a solar panel array disposed on a vehicle at a conversion device, the conversion device electrically connected to the solar panel array, the conversion device having a direct electrical connection to an internal component of a charging module, the charging module connected to a battery system of the vehicle;
stepping up the low voltage electrical power to generate stepped up electrical power and transmitting the stepped up electrical power to the internal component; and
transmitting the stepped up electrical power to at least one of the battery system and an external system.

11. The method of claim 10, wherein the charging module includes a direct current (DC)-DC converter, the direct electrical connection is to the DC-DC converter or to a DC link within the charging module, and transmitting the stepped up electrical power includes providing the stepped up electrical power via the direct electrical connection and converting the stepped up electrical power to high voltage electrical power and charging the battery system.

12. The method of claim 10, wherein the charging module includes a rectifier connected to the DC link and a charge port, and transmitting the stepped up electrical power includes converting the stepped up electrical power to AC power.

13. The method of claim 10, wherein the stepped up electrical power from the solar panel array is transmitted from the conversion device solely to the charging module.

14. The method of claim 10, wherein the solar power array includes a plurality of solar panel arrays, the conversion device is an isolated DC-DC converter, and the plurality of solar panel arrays are connected in parallel to the isolated DC-DC converter.

15. The method of claim 10, wherein the solar power array includes a plurality of solar panel arrays, and the conversion device includes a respective isolated DC-DC converter connected to each solar panel array.

16. The method of claim 10, wherein the conversion device is an isolated DC-DC converter, and the solar power array includes a plurality of solar panel arrays, each solar panel array connected to the isolated DC-DC converter via a respective maximum power point tracking (MPPT) converter.

17. A vehicle system, comprising:
a solar panel array disposed on a vehicle, the solar panel array configured to supply solar power to the vehicle;
a battery system configured to supply power to one or more components of the vehicle system;
a charging module connected to the battery system, the charging module including a direct current (DC)-DC converter;
a solar power system including a conversion device electrically connected to the solar panel array, the conversion device having a direct electrical connection to an internal component of the charging module; and
a controller configured to control operation of the conversion device and the charging module to transfer power from the solar panel array to the battery system, or to transfer power from the solar panel array to an external electrical system.

18. The vehicle system of claim 17, wherein the internal component is a DC link, the charging module includes a rectifier connected to the DC-DC converter by the DC link, and the conversion device is directly connected to a midpoint of the DC link.

19. The vehicle system of claim 17, wherein the internal component is a DC link, and the direct electrical connection is a direct DC connection to the DC link.

20. The vehicle system of claim 17, wherein the direct electrical connection is between the conversion device and the DC-DC converter.
